(19) United States
(12) Patent Application Publication
(10) Pub. No.: US 2005/0200162 A1
(43) Pub. Date: Sep. 15, 2005

(54) RETRACTABLE BRACKET DEVICE AND METHOD OF USING

(76) Inventor: Robert E. Kisor, Mansfield, OH (US)

Correspondence Address: Robert E. Kisor, P.O. Box 1374, Mansfield, OH, 44901-1374, US

(21) Appl. No.: 10/800,459

(22) Filed: Mar. 15, 2004

(51) Int. Cl. B62D 35/00

(52) U.S. Cl. 296/180.1

(57) ABSTRACT

A retractable bracket device and associated method of using the device for attachment to an air deflector unit onto a truck capable of pulling a trailer is disclosed. The device comprises a pedestal; a first, second, third, and fourth hinges; an extender arm; a platform; a first and a second threaded nut; and a first and a second shanks. The air deflector unit is mountable onto the platform of the device. The device is capable of being compacted into a fully folded position when not in use and uncompacted into a fully extended position for directing air flow from the cab of the truck over the towed trailer. The method of using the device comprises the steps of adjoining, affixing, attaching, hooking, inserting, loosening, obtaining, placing, raising, revolving, rotating, swinging, tightening, towing, unhooking, and withdrawing

### FIELD OF THE INVENTION

The present invention relates to air drag reducing devices, more particularly, to a retractable bracket device and associated method of using the device in conjunction with a air deflector unit.

### DESCRIPTION OF THE PRIOR ART

Due to rapidly increasing fuel costs considerable attention has been given in recent years to improving the efficiency of heavy trucks. One aspect of truck design that has been given particular attention is the aerodynamic configuration of the vehicle. Traditionally, the external configuration of such trucks has been primarily determined by various functional requirements and particularly the need to maximize the volumetric load capacity of the vehicle within given height, width and length requirements. Streamlining was not a major consideration and was not generally considered to be economically justifiable, but the recent sharp increases in fuel costs have altered the economic situation. Because approximately one-half the fuel used by a typical tractor-trailer at highway speeds is spent overcoming aerodynamic drag, measurable savings in operating costs can be achieved by reducing drag on these vehicles.

A wide variety of air drag reducing devices is currently available on the commercial market and an even larger number of these types of devices are known in the art of air drag reducing devices, for example, the drag reduction apparatus and method disclosed by Tatom in U.S. Pat. No. 3,951,445; the air deflector assembly disclosed by Stephens in U.S. Pat. No. 4,375,898; the mounting of airfoil members on land vehicles disclosed by Forster in U.S. Pat. No. 4,406,491; the air deflector apparatus disclosed by Peairs in U.S. Pat. No. 4,607,874; the air foil system disclosed by Straight in U.S. Pat. No. 4,779,915; and the pickup truck wind deflector disclosed by Powell, Jr. in U.S. Pat. No. D332,245.

While all of the above-described devices fulfill their respective, particular objectives and requirements, the aforementioned patents do not describe a retractable bracket device having a pedestal; a first, second, third, and fourth hinges; an extender arm; a platform; a first and a second threaded nut; and a first and a second shanks. This combination of elements would specifically match the user's particular individual needs of making it possible to

Even still another object of the present invention is to provide a retractable bracket device having a pedestal; a first, second, third, and fourth hinges; an extender arm; a platform; a first and a second threaded nut; and a first and a second shanks. This combination of elements makes it possible to attach the air deflector unit onto the platform of the device so that the device can be telescopically collapsed in to a fully folded position when not in use and telescopically extended into a fully extended position for use in directing air flow from the cab of the truck over the towed trailer. The above-described patents make no provision for a retractable bracket device having a pedestal; a first, second, third, and fourth hinges; an extender arm; a platform; a first and a second threaded nut; and a first and a second shanks.

Therefore, a need exists for a new and improved retractable bracket device having a pedestal; a first, second, third, and fourth hinges; an extender arm; a platform; a first and a second threaded nut; and a first and a second shanks. In this respect, the retractable bracket device according to the present invention substantially departs from the conventional concepts and designs of the prior art, and in doing so provides an apparatus primarily developed for the purpose of providing a mean for attaching the air deflector unit onto the platform of the device so that the the device can be telescopically collapsed in to a fully folded position when not in use and telescopically extended into a fully extended position for use in directing air flow from the cab of the truck over the towed trailer.

### SUMMARY OF THE INVENTION

The present device and method of using, according to the principles of the present invention, overcomes the shortcomings of the prior art by providing a retractable bracket device and method are disclosed. The device comprises a pedestal; a first, second, third, and fourth hinges; an extender arm; a platform; a first and a second threaded nut; and a first and a second shanks. The air deflector unit is mountable onto the platform of the device. The device is capable of being compacted into a fully folded position when not in use and uncompacted into a fully extended position for directing air flow from the cab of the truck over the towed trailer. The method of using the device comprises the steps of adjoining, affixing, attaching, hooking, inserting, loosening, obtaining, placing, raising, revolving, rotating, swinging, tightening, towing, unhooking, and withdrawing

In view of the foregoing disadvantages inherent in the known type retractable bracket devices now present in the prior art, the present invention provides an improved retractable bracket device, which will be described subsequently in great detail, is to provide a new and improved retractable bracket device which is not anticipated, rendered obvious, suggested, or even implied by the prior art, either alone or in any combination thereof.

To attain this, the present invention essentially comprises a pedestal; a first, second, third, and fourth hinges; an extender arm; a platform; a first and a second threaded nut; and a first and a second shanks. The air deflector unit is mountable onto the platform of the device. The device is capable of being compacted into a fully folded position when not in use and uncompacted into a fully extended position for directing air flow from the cab of the truck over the towed trailer.

There has thus been outlined, rather broadly, the more important features of the invention in order that the detailed description thereof that follows may be better understood, and in order that the present contribution of the art may be better appreciated.

The invention may also include an optional shank attached to the footer of the pedestal. There are of course, additional features of the invention that will be described hereinafter and which will form the subject matter of the claims attached.

Numerous objects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved retractable bracket device that has all the advantages of the prior art retractable bracket device and none of the disadvantages.

It is another object of the present invention to provide a new and improved retractable bracket device that may be easily and efficiently manufactured and marketed.

An even further object of the present invention is to provide a new and improved retractable bracket device that has a low cost of manufacture with regard to both materials and labor, and which accordingly is then susceptible of low prices of sale to the consuming public, thereby making such multipurpose storage unit and system economically available to the buying public.

Still another object of the present invention is to provide a new retractable bracket device that provides in the apparatuses and methods of the prior art some of the advantages thererof, while simultaneously overcoming some of the disadvantages normally associated therewith.

Even still another object of the present invention is to provide a retractable bracket device having a pedestal; a first, second, third, and fourth hinges; an extender arm; a platform; a first and a second threaded nut; and a first and a second shanks. This combination of elements makes it possible to attach the air deflector unit onto the platform of the device so that the the device can be telescopically collapsed in to a fully folded position when not in use and telescopically extended into a fully extended position for use in directing air flow from the cab of the truck over the towed trailer.

Lastly, it is an object of the present invention to provide a new and improved method of using comprising the steps of adjoining, affixing, attaching, hooking, inserting, loosening, obtaining, placing, raising, revolving, rotating, swinging, tightening, towing, unhooking, and withdrawing.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way:

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and description matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top plan view of an preferred embodiment of the retractable bracket device constructed in accordance with the principles of the present invention;

FIG. 2 is a side view of a fully extended preferred embodiment of the retractable bracket device of the present invention;

FIG. 3 is a rear view of a preferred embodiment of the retractable bracket device of the present invention; and

FIG. 4 is a side view of a fully folded preferred embodiment of the retractable bracket device of the present invention.

The same reference numerals refer to the same parts throughout the various figures.

### DETAILED DESCRIPTION OF THE PREFERRED EMBODIMENT

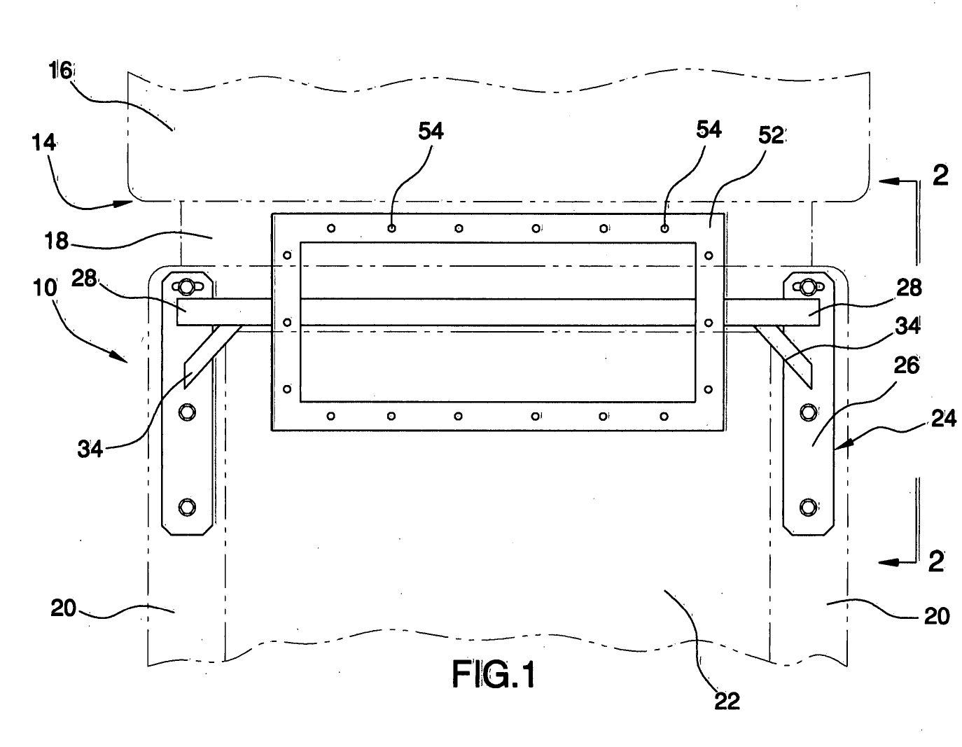

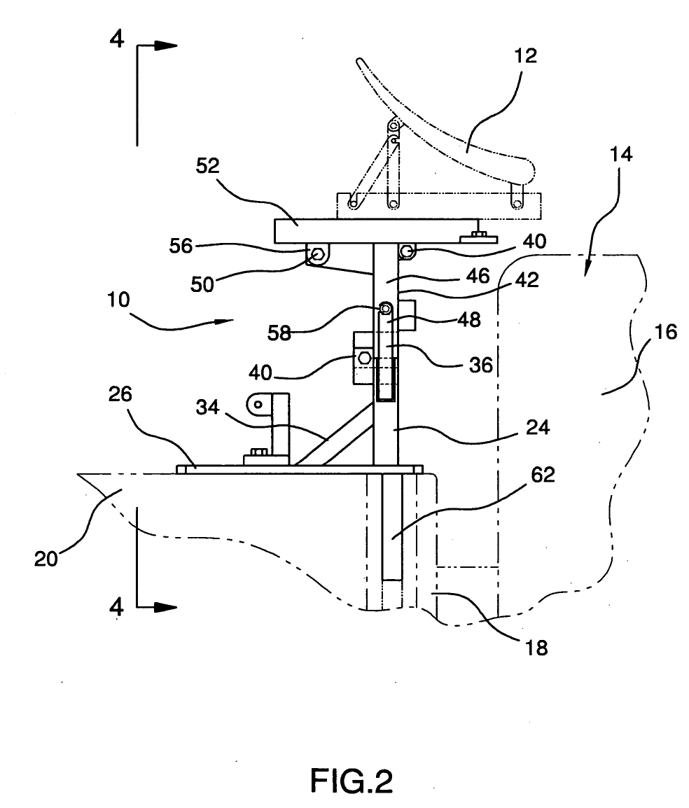

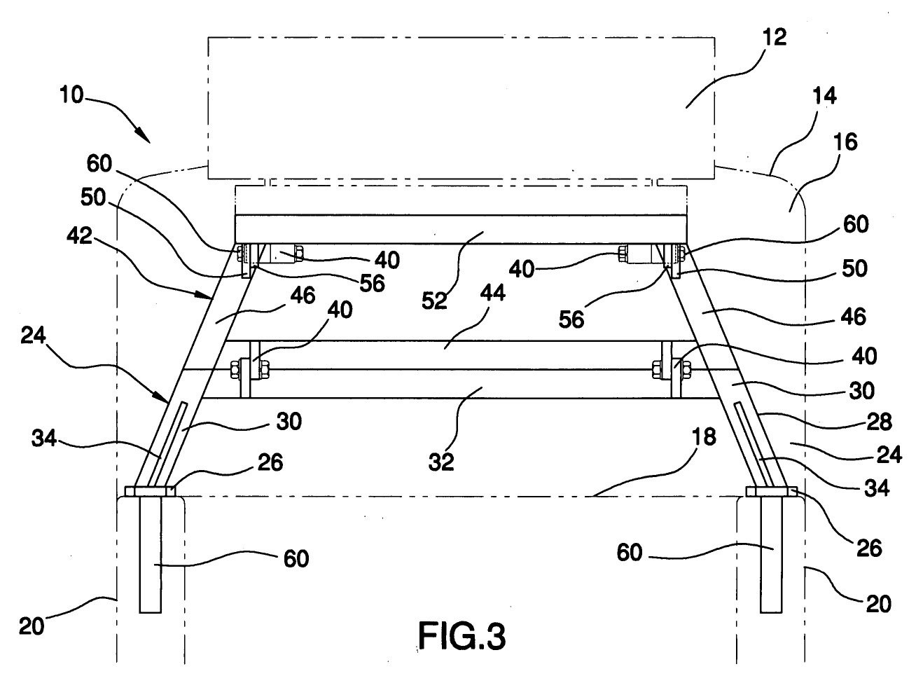

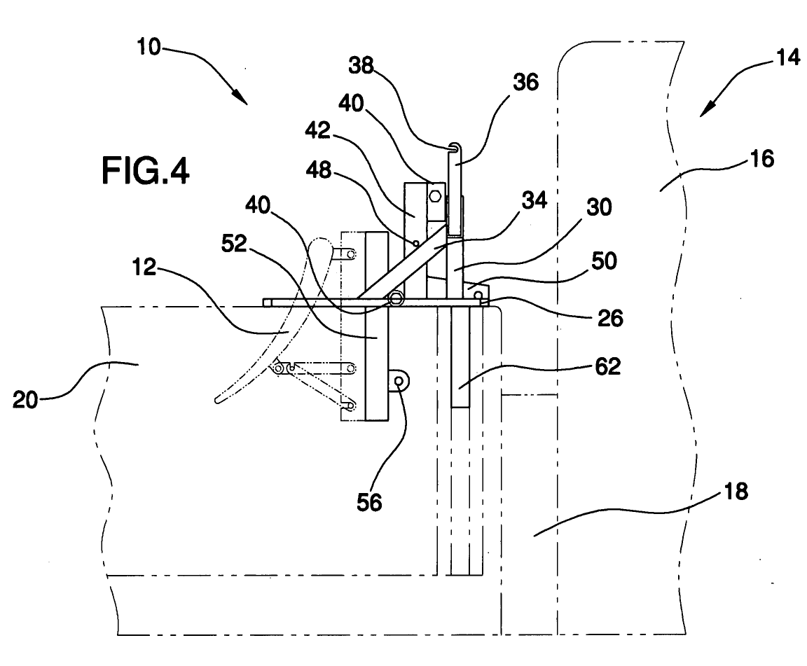

Referring now to the drawings, and in particular FIG. 1 to 4 thereof, one preferred embodiment of the present invention is shown and generally designated by the reference numeral 10. A preferred embodiment of an retractable bracket device 10 for attachment to an air deflector unit 12, the device 10 for fitment onto a truck 14 capable of pulling a trailer, the truck 14 having a cab 16, a front bed wall 18, a first side bed wall 20, a second side bed wall 20 and a flat bed flooring 22 disposed between the front bed wall 18 and the two opposing side bed walls 20 of the truck 14, the device 10 comprising: a pedestal 24; a first, second, third, and fourth hinges; an extender arm 42; a platform 52; a first and a second threaded nut 58; and a first and a second shanks 60. The pedestal 24 is attachable to the truck 14, the pedestal 24 including: a first footer 26 attachable to the first side bed wall 20 of the truck 14; a second footer 26 attachable to the second side bed wall 20 of the truck 14; an arch 28 attached to the first and second footers 26 of the pedestal 24, the arch 28 having a first post 30, a second post 30 and a crossbar 32, the first post 30 of the arch 28 is attached to the first footer 26, the second post 30 of the arch 28 is attached to the second footer 26, the crossbar 32 is attached to the first and second posts 30 of the arch 28; a first support gusset 34 attached to the first footer 26 and attached to the first post 30 of the arch 28; a second support gusset 34 attached to the second footer 26 and attached to the second post 30 of the arch 28; a first mounting flap 36 attached to the first post 30 of the arch 28, the first mounting flap 36 having a first arcuately curved hook distal end defining a first crevice 38 in the distal end of the first mounting flap 36; and a second mounting flap 36 attached to the second post 30 of the arch 28, the second mounting flap 36 having a second arcuately curved hook distal end defining a second crevice 38 in the distal end of the second bracket. The first hinge 40 is attached to the crossbar 32 of the arch 28. The second hinge 40 is attached to the crossbar 32 of the arch 28. The extender arm 42 is attached to the first and second hinges 40, whereby the extender arm 42 is pivotally attached to the pedestal 24, the extender arm 42 including: a base member 44 attached to the first and second hinges 40; a first post 30 member attached to the base member 44, the first leg 46 member having a first threaded shaft 48 protruding outwardly from one side of the first leg 46 member; a second leg 46 member attached to the base member 44, the second leg 46 member having a second threaded shaft 48 protruding outwardly from one side of the second leg 46 member; a first brace 50 attached to the first leg 46 member, the first brace 50 having a first sleeve defining a first hole in the first brace 50; and a second brace 50 attached to the second leg 46 member, the second brace 50 having a second sleeve defining a second hole of the second brace 50, wherein when the extender arm 42 is pivoted towards the arch 28 of the pedestal 24 then the device 10 is in a lower folded position, and when the extender arm 42 is pivoted away from the arch 28 of the pedestal 24 so that the respective first and second shafts 48 of the first and second leg 46 members of the extender arm 42 are slidably inserted within the respective first and second crevices 38 of the first and second mounting flaps 36 then the device 10 is in a straightened position. The third hinge 40 is attached to the first leg 46 member of the extender arm 42. The fourth hinge 40 is attached to the second leg 46 member of the extender arm 42. The platform 52 attached to the third and fourth hinges 40, whereby the platform 52 is pivotally attached to the extender arm 42, the platform 52 having a generally flat top and a bottom, the platform 52 including: a plurality of collars traversing through the top of the platform 52 to the bottom of the platform 52, the plurality of collars defining a plurality of orifices 54 in the platform 52, wherein the top of the platform 52 and the plurality of orifices 54 are for mounting onto the air deflector unit 12; a first flange 56 attached to the bottom of the platform 52, the first flange 56 having a first interior annular wall defining a first aperture extending through the first flange 56; and a second flange 56 attached to the bottom of the platform 52, the second flange 56 having a second interior annular wall defining a second aperture extending through the second flange 56, wherein when the platform 52 is pivoted towards the extender arm 42 then the device 10 is in an upper folded position, and when the device 10 is simultaneously in the lower folded position and in the upper folded position then the device 10 is in the fully folded position. The first threaded nut 58 is threadedly connectable to the first threaded shaft 48 of the first leg 46 member of the extender arm 42. The second threaded nut 58 threadedly connectable to the second threaded shaft 48 of the second leg 46 member of the extender arm 42. When the device 10 is in the straightened position and when the respective first and second nuts 58 are tightened over the respective first and second shafts 48 then the device 10 is in a lower locked position. When the platform 52 is pivoted away from the extension arm 42 so that the first and second braces 50 of the extension arm 42 contact the bottom of the platform 52 then the device 10 is in an semi-unfolded position. The first shank 60 is insertable within the first aperture of the first flange 56 of the platform 52, wherein the first shank 60 is also insertable within the first hole in the first brace 50. The second shank 60 insertable within the second aperture of the first flange 56 of the platform 52, wherein the second shank 60 is also insertable within the second hole of the second brace 50. When the device 10 is the semi-unfolded position and when the respective first and second shanks 60 are inserted within the respective first and second holes of the respective first and second braces 50 and inserted through the respective first and second apertures of the respective first and second flanges 56 of the platform 52 then the device 10 is in an upper locked position. When the device 10 is simultaneously in the lower locked position and is in the upper locked position then the device 10 is in a fully extended position.

An optional first rod 62 may be added to the device in which the first rod 62 is attached to the first footer 26 of the pedestal 24, the first rod 62 for insertion into a first aperture in the first side bed wall 20 of the truck 14.

An optional second rod 62 may also be added to the device in which the second rod 62 is attached to the second footer 26 of the pedestal 24, the second rod 62 for insertion into a second aperture in the first side bed wall 20 of the truck 14.

The device may be constructed from any commercially known material. One preferred configuration is that the device 10 is made of metal selected from the group consisting of aluminum, scandium, titanium, vanadium, chromium, manganese, iron, cobalt, nickel, copper, zinc, yttrium, zirconium, niobium, molybdenum, ruthenium, rhodium, palladium, and mixtures thereof. A most preferred configuration is that the device 10 is made of stainless steel. Yet another preferred configuration is that the device 10 is made of powder coated material. Even yet another preferred configuration is that the device 10 is made of plastic selected from the group consisting of polyester, polypropylene, polyurethanes, polyacryls, polymethacryls, cellulosic polymers, styrene-acryl copolymers, polystyrene-polyacryl mixtures, polysiloxanes, urethane-acryl copolymers, siloxane-urethane copolymers, polyurethane-polymethacryl mixtures, silicone-acryl copolymers, vinyl acetate polymers, and mixtures thereof.

The shanks 60 may be any commercially available means for latching together two objects. One preferred is that the shanks 60 are threaded bolts.

Another preferred embodiment of the device 10 consisting essentially of: a pedestal 24 attachable to the truck 14, the pedestal 24 including: a first footer 26 attachable to the first side bed wall 20 of the truck 14; a second footer 26 attachable to the second side bed wall 20 of the truck 14; an arch 28 attached to the first and second footers 26 of the pedestal 24, the arch 28 having a first post 30, a second post 30 and a crossbar 32, the first post 30 of the arch 28 is attached to the first footer 26, the second post 30 of the arch 28 is attached to the second footer 26, the crossbar 32 is attached to the first and second posts 30 of the arch 28; a first support gusset 34 attached to the first footer 26 and attached to the first post 30 of the arch 28; a second support gusset 34 attached to the second footer 26 and attached to the second post 30 of the arch 28; a first mounting flap 36 attached to the first post 30 of the arch 28, the first mounting flap 36 having a first arcuately curved hook distal end defining a first crevice 38 in the distal end of the first mounting flap 36; and a second mounting flap 36 attached to the second post 30 of the arch 28, the second mounting flap 36 having a second arcuately curved hook distal end defining a second crevice 38 in the distal end of the second bracket; a first hinge 40 attached to the crossbar 32 of the arch 28; a second hinge 40 attached to the crossbar 32 of the arch 28; an extender arm 42 attached to the first and second hinges 40, whereby the extender arm 42 is pivotally attached to the pedestal 24, the extender arm 42 including: a base member 44 attached to the first and second hinges 40; a first leg 46 member attached to the base member 44, the first leg 46 member having a first threaded shaft 48 protruding outwardly from one side of the first leg 46 member; a second leg 46 member attached to the base member 44, the second leg 46 member having a second threaded shaft 48 protruding outwardly from one side of the second leg 46 member; a first brace 50 attached to the first leg 46 member, the first brace 50 having a first sleeve defining a first hole in the first brace 50; and a second brace 50 attached to the second leg 46 member, the second brace 50 having a second sleeve defining a second hole of the second brace 50, wherein when the extender arm 42 is pivoted towards the arch 28 of the pedestal 24 then the device 10 is in a lower folded position, and when the extender arm 42 is pivoted away from the arch 28 of the pedestal 24 so that the respective first and second shafts 48 of the first and second leg 46 members of the extender arm 42 are slidably inserted within the respective first and second crevices 38 of the first and second mounting flaps 36 then the device 10 is in a straightened position; a third hinge 40 attached to the first leg 46 member of the extender arm 42; a fourth hinge 40 attached to the second leg 46 member of the extender arm 42; a platform 52 attached to the third and fourth hinges 40, whereby the platform 52 is pivotally attached to the extender arm 42, the platform 52 having a generally flat top and a bottom, the platform 52 including: a plurality of collars traversing through the top of the platform 52 to the bottom of the platform 52, the plurality of collars defining a plurality of orifices 54 in the platform 52, wherein the top of the platform 52 and the plurality of orifices 54 are for mounting onto the air deflector unit 12; a first flange 56 attached to the bottom of the platform 52, the first flange 56 having a first interior annular wall defining a first aperture extending through the first flange 56; and a second flange 56 attached to the bottom of the platform 52, the second flange 56 having a second interior annular wall defining a second aperture extending through the second flange 56, wherein when the platform 52 is pivoted towards the extender arm 42 then the device 10 is in an upper folded position, and when the device 10 is simultaneously in the lower folded position and in the upper folded position then the device 10 is in the fully folded position; a first threaded nut 58 threadedly connectable to the first threaded shaft 48 of the first leg 46 member of the extender arm 42; a second threaded nut 58 threadedly connectable to the second threaded shaft 48 of the second leg 46 member of the extender arm 42, wherein when the device 10 is in the straightened position and when the respective first and second nuts 58 are tightened over the respective first and second shafts 48 then the device 10 is in a lower locked position, and when the platform 52 is pivoted away from the extension arm 42 so that the first and second braces 50 of the extension arm 42 contact the bottom of the platform 52 then the device 10 is in an semi-unfolded position; a first shank 60 insertable within the first aperture of the first flange 56 of the platform 52, the first shank 60 is also insertable within the first hole in the first brace 50; and a second shank 60 insertable within the second aperture of the first flange 56 of the platform 52, the second shank 60 is also insertable within the second hole of the second brace 50, wherein when the device 10 is the semi-unfolded position and when the respective first and second shanks 60 are inserted within the respective first and second holes of the respective first and second braces 50 and inserted through the respective first and second apertures of the respective first and second flanges 56 of the platform 52 then the device 10 is in an upper locked position, and when the device 10 is simultaneously in the lower locked position and is in the upper locked position then the device 10 is in a fully extended position.

One preferred embodiment of a method of using a retractable bracket device 10 for attachment to an air deflector unit 12, the device 10 for fitment onto a truck 14 capable of pulling a trailer, the truck 14 having a cab 16, a front bed wall 18, a first side bed wall 20, a second side bed wall 20 and a flat bed flooring 22 disposed between the front bed wall 18 and the two opposing side bed walls 20 of the truck 14, the method comprising the steps of: adjoining, affixing, attaching, hooking, inserting, loosening, obtaining, placing, raising, revolving, rotating, swinging, tightening, towing, unhooking, and withdrawing. The obtaining step comprises obtaining the device 10 comprising: a pedestal 24 attachable to the truck 14, the pedestal 24 including: a first footer 26 attachable to the first side bed wall 20 of the truck 14; a second footer 26 attachable to the second side bed wall 20 of the truck 14; an arch 28 attached to the first and second footers 26 of the pedestal 24, the arch 28 having a first post 30, a second post 30 and a crossbar 32, the first post 30 of the arch 28 is attached to the first footer 26, the second post 30 of the arch 28 is attached to the second footer 26, the crossbar 32 is attached to the first and second posts 30 of the arch 28; a first support gusset 34 attached to the first footer 26 and attached to the first post 30 of the arch 28; a second support gusset 34 attached to the second footer 26 and attached to the second post 30 of the arch 28; a first mounting flap 36 attached to the first post 30 of the arch 28, the first mounting flap 36 having a first arcuately curved hook distal end defining a first crevice 38 in the distal end of the first mounting flap 36; and a second mounting flap 36 attached to the second post 30 of the arch 28, the second mounting flap 36 having a second arcuately curved hook distal end defining a second crevice 38 in the distal end of the second bracket; a first hinge 40 attached to the crossbar 32 of the arch 28; a second hinge 40 attached to the crossbar 32 of the arch 28; an extender arm 42 attached to the first and second hinges 40, whereby the extender arm 42 is pivotally attached to the pedestal 24, the extender arm 42 including: a base member 44 attached to the first and second hinges 40; a first leg 46 member attached to the base member 44, the first leg 46 member having a first threaded shaft 48 protruding outwardly from one side of the first leg 46 member; a second leg 46 member attached to the base member 44, the second leg 46 member having a second threaded shaft 48 protruding outwardly from one side of the second leg 46 member; a first brace 50 attached to the first leg 46 member, the first brace 50 having a first sleeve defining a first hole in the first brace 50; and a second brace 50 attached to the second leg 46 member, the second brace 50 having a second sleeve defining a second hole of the second brace 50, wherein when the extender arm 42 is pivoted towards the arch 28 of the pedestal 24 then the device 10 is in a lower folded position, and when the extender arm 42 is pivoted away from the arch 28 of the pedestal 24 so that the respective first and second shafts 48 of the first and second leg 46 members of the extender arm 42 are slidably inserted within the respective first and second crevices 38 of the first and second mounting flaps 36 then the device 10 is in a straightened position; a third hinge 40 attached to the first leg 46 member of the extender arm 42; a fourth hinge 40 attached to the second leg 46 member of the extender arm 42; a platform 52 attached to the third and fourth hinges 40, whereby the platform 52 is pivotally attached to the extender arm 42, the platform 52 having a generally flat top and a bottom, the platform 52 including: a plurality of collars traversing through the top of the platform 52 to the bottom of the platform 52, the plurality of collars defining a plurality of orifices 54 in the platform 52, wherein the top of the platform 52 and the plurality of orifices 54 are for mounting onto the air deflector unit 12; a first flange 56 attached to the bottom of the platform 52, the first flange 56 having a first interior annular wall defining a first aperture extending through the first flange 56; and a second flange 56 attached to the bottom of the platform 52, the second flange 56 having a second interior annular wall defining a second aperture extending through the second flange 56, wherein when the platform 52 is pivoted towards the extender arm 42 then the device 10 is in an upper folded position, and when the device 10 is simultaneously in the lower folded position and in the upper folded position then the device 10 is in the fully folded position; a first threaded nut 58 threadedly connectable to the first threaded shaft 48 of the first leg 46 member of the extender arm 42; a second threaded nut 58 threadedly connectable to the second threaded shaft 48 of the second leg 46 member of the extender arm 42, wherein when the device 10 is in the straightened position and when the respective first and second nuts 58 are tightened over the respective first and second shafts 48 then the device 10 is in a lower locked position, and when the platform 52 is pivoted away from the extension arm 42 so that the first and second braces 50 of the extension arm 42 contact the bottom of the platform 52 then the device 10 is in an semi-unfolded position; a first shank 60 insertable within the first aperture of the first flange 56 of the platform 52, the first shank 60 is also insertable within the first hole in the first brace 50; and a second shank 60 insertable within the second aperture of the first flange 56 of the platform 52, the second shank 60 is also insertable within the second hole of the second brace 50, wherein when the device 10 is the semi-unfolded position and when the respective first and second shanks 60 are inserted within the respective first and second holes of the respective first and second braces 50 and inserted through the respective first and second apertures of the respective first and second flanges 56 of the platform 52 then the device 10 is in an upper locked position, and when the device 10 is simultaneously in the lower locked position and is in the upper locked position then the device 10 is in a fully extended position. The placing step comprises placing the device 10 into the fully folded position. The attaching step comprises attaching firmly the air deflector unit 12 onto the top of the platform 52 of the device 10. The adjoining step comprises adjoining the first footer 26 of the pedestal 24 of the device 10 onto the first side bed wall 20 of the truck 14. The affixing step comprises affixing the second footer 26 of the pedestal 24 of the device 10 onto the second side bed wall 20 of the truck 14. The rotating step comprises rotating pivotally the extender arm 42 away from the arch 28 of the pedestal 24 so that the respective first and second shafts 48 of the first and second leg 46 members of the extender arm 42 are slidably inserted within the respective first and second crevices 38 of the first and second mounting flaps 36, whereby moving the device 10 form the fully folded position to the straightened position. The tightening step comprises tightening the respective first and second nuts 58 onto the respective first and second shafts 48 when the device 10 is in the straightened position whereby moving the device 10 from the straightened position to the lower locked position. The raising step comprises raising pivotally the platform 52 away from the extension arm 42 so that the first and second braces 50 of the extension arm 42 contact the bottom of the platform 52 whereby moving the device 10 from the lower locked position to the semi-unfolded position. The inserting step comprises inserting the respective first and second shanks 60 into the respective first and second holes of the respective first and second braces 50 and through the respective first and second apertures of the respective first and second flanges 56 of the platform 52, whereby moving the device 10 from the semi-unfolded position to the fully extended position. The hooking step comprises hooking up the trailer to the truck 14. The towing step comprises towing the trailer with the truck 14 when the device 10 is in the fully extended position and when the air deflector unit 12 is attached to the device 10. The unhooking step comprises unhooking the trailer from the truck 14. The withdrawing step comprises withdrawing the respective first and second shanks 60 from the respective first and second holes of the respective first and second braces 50 and from the respective first and second apertures of the respective first and second flanges 56 of the platform 52, whereby moving the device 10 from the fully extended position to the semi-unfolded position. The swinging step comprises swinging pivotally the platform 52 towards the extender arm 42, whereby moving the device 10 form the semi-unfolded position to the upper folded position. The loosening step comprises loosening the first and second nuts 58 from the respective first and second shafts 48, whereby moving the device 10 form the upper folded position to the straightened position. The revolving step comprises revolving pivotally the extender arm 42 towards the arch 28 of the pedestal 24, whereby moving the device 10 from the straightened position to the fully folded position.

Another preferred embodiment of a method of using a retractable bracket device 10 for attachment to an air deflector unit 12, the device 10 for fitment onto a truck 14 capable of pulling a trailer, the truck 14 having a cab 16, a front bed wall 18, a first side bed wall 20, a second side bed wall 20 and a flat bed flooring 22 disposed between the front bed wall 18 and the two opposing side bed walls 20 of the truck 14, the method consist essentially of the steps of: adjoining, affixing, attaching, hooking, inserting, loosening, obtaining, placing, raising, revolving, rotating, swinging, tightening, towing, unhooking, and withdrawing.

As to the manner of usage and operation of the present invention, the same should be apparent from the above description. Accordingly, no further discussion relating to the manner of usage and operation will be provided.

While a preferred embodiment of the retractable bracket device has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modifications which fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An retractable bracket device for attachment to an air deflector unit, said device for fitment onto a truck capable of pulling a trailer, the truck having a cab, a front bed wall, a first side bed wall, a second side bed wall and a flat bed flooring disposed between the front bed wall and the two side bed walls of the truck, said device comprising:
a pedestal attachable to the truck, said pedestal including:
a first footer attachable to the first side bed wall of the truck;
a second footer attachable to the second side bed wall of the truck;
an arch attached to said first and second footers of said pedestal, said arch having a first post, a second post and a crossbar, said first post of said arch is attached to said first footer, said second post of said arch is attached to said second footer, said crossbar is attached to said first and second posts of said arch;
a first support gusset attached to said first footer and attached to the first post of said arch;
a second support gusset attached to said second footer and attached to said second post of said arch;
a first mounting flap attached to said first post of said arch, said first mounting flap having a first arcuately curved hook distal end defining a first crevice in the distal end of said first mounting flap; and
a second mounting flap attached to said second post of said arch, said second mounting flap having a second arcuately curved hook distal end defining a second crevice in the distal end of said second bracket;
a first hinge attached to said crossbar of said arch;
a second hinge attached to said crossbar of said arch;
an extender arm attached to said first and second hinges, whereby said extender arm is pivotally attached to said pedestal, said extender arm including:
a base member attached to said first and second hinges;
a first leg member attached to said base member, said first leg member having a first threaded shaft protruding outwardly from one side of said first leg member;
a second leg member attached to said base member, said second leg member having a second threaded shaft protruding outwardly from one side of said second leg member;
a first brace attached to said first leg member, said first brace having a first sleeve defining a first hole in said first brace; and
a second brace attached to said second leg member, said second brace having a second sleeve defining a second hole of said second brace,
wherein when said extender arm is pivoted towards said arch of said pedestal then said device is in a lower folded position, and
when said extender arm is pivoted away from said arch of said pedestal so that said respective first and second shafts of said first and second leg members of said extender arm are slidably inserted within said respective first and second crevices of said first and second mounting flaps then said device is in a straightened position;
a third hinge attached to said first leg member of said extender arm;
a fourth hinge attached to said second leg member of said extender arm;
a platform attached to said third and fourth hinges, whereby said platform is pivotally attached to said extender arm, said platform having a generally flat top and a bottom, said platform including:
a plurality of collars traversing through the top of said platform to the bottom of said platform, said plurality of collars defining a plurality of orifices in said platform, wherein said top of said platform and said plurality of orifices are for mounting onto the air deflector unit;
a first flange attached to the bottom of said platform, said first flange having a first interior annular wall defining a first aperture extending through said first flange; and
a second flange attached to the bottom of said platform, said second flange having a second interior annular wall defining a second aperture extending through said second flange,
wherein when said platform is pivoted towards said extender arm then said device is in an upper folded position, and
when said device is simultaneously in the lower folded position and in the upper folded position then said device is in the fully folded position;
a first threaded nut threadedly connectable to said first threaded shaft of said first leg member of said extender arm;
a second threaded nut threadedly connectable to said second threaded shaft of said second leg member of said extender arm,
wherein when said device is in the straightened position and when said respective first and second nuts are tightened over said respective first and second shafts then said device is in a lower locked position, and
when said platform is pivoted away from said extension arm so that said first and second braces of said extension arm contact the bottom of said platform then said device is in an semi-unfolded position;
a first shank insertable within said first aperture of said first flange of said platform, said first shank is also insertable within said first hole in said first brace; and
a second shank insertable within said second aperture of said first flange of said platform, said second shank is also insertable within said second hole of said second brace,
wherein when said device is the semi-unfolded position and when said respective first and second shanks are inserted within said respective first and second holes of said respective first and second braces and inserted through said respective first and second apertures of said respective first and second flanges of said platform then said device is in an upper locked position, and
when said device is simultaneously in the lower locked position and is in the upper locked position then said device is in a fully extended position.

2. The device of claim 1 further comprising a first rod attached to said first footer of said pedestal, said first rod for insertion into a first aperture in the first side bed wall of the truck.

3. The device of claim 1 further comprising a second rod attached to said second footer of said pedestal, said second rod for insertion into a second aperture in the first side bed wall of the truck.

4. The device of claim 1 wherein said device is made of metal.

5. The device of claim 4 wherein said metal is selected from the group consisting of aluminum, scandium, titanium, vanadium, chromium, manganese, iron, cobalt, nickel, copper, zinc, yttrium, zirconium, niobium, molybdenum, ruthenium, rhodium, palladium, and mixtures thereof.

6. The device of claim 1 wherein said device is made of stainless steel.

7. The device of claim 1 wherein said device is made of powder coated material.

8. The device of claim 1 wherein said device is made of plastic.

9. The device of claim 8 wherein said plastic is selected from the group consisting of polyester, polypropylene, polyurethanes, polyacryls, polymethacryls, cellulosic polymers, styrene-acryl copolymers, polystyrene-polyacryl mixtures, polysiloxanes, urethane-acryl copolymers, siloxane-urethane copolymers, polyurethane-polymethacryl mixtures, silicone-acryl copolymers, vinyl acetate polymers, and mixtures thereof.

10. The device of claim 1 wherein said first shank is a first threaded bolt.

11. The device of claim 1 wherein said second shank is a second threaded bolt.

12. An retractable bracket device for attachment to an air deflector unit, said device for fitment onto a truck capable of pulling a trailer, the truck having a cab, a front bed wall, a first side bed wall, a second side bed wall and a flat bed flooring disposed between the front bed wall and the two side bed walls of the truck, said device consisting essentially of:
a pedestal attachable to the truck, said pedestal including:
a first footer attachable to the first side bed wall of the truck;
a second footer attachable to the second side bed wall of the truck;
an arch attached to said first and second footers of said pedestal, said arch having a first post, a second post and a crossbar, said first post of said arch is attached to said first footer, said second post of said arch is attached to said second footer, said crossbar is attached to said first and second posts of said arch;
a first support gusset attached to said first footer and attached to the first post of said arch;
a second support gusset attached to said second footer and attached to said second post of said arch;
a first mounting flap attached to said first post of said arch, said first mounting flap having a first arcuately curved hook distal end defining a first crevice in the distal end of said first mounting flap; and
a second mounting flap attached to said second post of said arch, said second mounting flap having a second arcuately curved hook distal end defining a second crevice in the distal end of said second bracket;
a first hinge attached to said crossbar of said arch;
a second hinge attached to said crossbar of said arch;
an extender arm attached to said first and second hinges, whereby said extender arm is pivotally attached to said pedestal, said extender arm including:
a base member attached to said first and second hinges;
a first leg member attached to said base member, said first leg member having a first threaded shaft protruding outwardly from one side of said first leg member;
a second leg member attached to said base member, said second leg member having a second threaded shaft protruding outwardly from one side of said second leg member;
a first brace attached to said first leg member, said first brace having a first sleeve defining a first hole in said first brace; and
a second brace attached to said second leg member, said second brace having a second sleeve defining a second hole of said second brace,
wherein when said extender arm is pivoted towards said arch of said pedestal then said device is in a lower folded position, and
when said extender arm is pivoted away from said arch of said pedestal so that said respective first and second shafts of said first and second leg members of said extender arm are slidably inserted within said respective first and second crevices of said first and second mounting flaps then said device is in a straightened position;
a third hinge attached to said first leg member of said extender arm;
a fourth hinge attached to said second leg member of said extender arm;
a platform attached to said third and fourth hinges, whereby said platform is pivotally attached to said extender arm, said platform having a generally flat top and a bottom, said platform including:
a plurality of collars traversing through the top of said platform to the bottom of said platform, said plurality of collars defining a plurality of orifices in said platform, wherein said top of said platform and said plurality of orifices are for mounting onto the air deflector unit;
a first flange attached to the bottom of said platform, said first flange having a first interior annular wall defining a first aperture extending through said first flange; and
a second flange attached to the bottom of said platform, said second flange having a second interior annular wall defining a second aperture extending through said second flange,
wherein when said platform is pivoted towards said extender arm then said device is in an upper folded position, and
when said device is simultaneously in the lower folded position and in the upper folded position then said device is in the fully folded position;
a first threaded nut threadedly connectable to said first threaded shaft of said first leg member of said extender arm;
a second threaded nut threadedly connectable to said second threaded shaft of said second leg member of said extender arm,
wherein when said device is in the straightened position and when said respective first and second nuts are tightened over said respective first and second shafts then said device is in a lower locked position, and
when said platform is pivoted away from said extension arm so that said first and second braces of said extension arm contact the bottom of said platform then said device is in an semi-unfolded position;
a first shank insertable within said first aperture of said first flange of said platform, said first shank is also insertable within said first hole in said first brace; and
a second shank insertable within said second aperture of said first flange of said platform, said second shank is also insertable within said second hole of said second brace,
wherein when said device is the semi-unfolded position and when said respective first and second shanks are inserted within said respective first and second holes of said respective first and second braces and inserted through said respective first and second apertures of said respective first and second flanges of said platform then said device is in an upper locked position, and
when said device is simultaneously in the lower locked position and is in the upper locked position then said device is in a fully extended position.

13. The device of claim 12 wherein said device is made of metal.

14. The device of claim 13 wherein said metal is selected from the group consisting of aluminum, scandium, titanium, vanadium, chromium, manganese, iron, cobalt, nickel, copper, zinc, yttrium, zirconium, niobium, molybdenum, ruthenium, rhodium, palladium, and mixtures thereof.

15. The device of claim 12 wherein said device is made of stainless steel.

16. The device of claim 12 wherein said device is made of powder coated material.

17. The device of claim 12 wherein said device is made of plastic selected from the group consisting of polyester, polypropylene, polyurethanes, polyacryls, polymethacryls, cellulosic polymers, styrene-acryl copolymers, polystyrene-polyacryl mixtures, polysiloxanes, urethane-acryl copolymers, siloxane-urethane copolymers, polyurethane-polymethacryl mixtures, silicone-acryl copolymers, vinyl acetate polymers, and mixtures thereof.

18. The device of claim 12 wherein said first shank is a first threaded bolt.

19. The device of claim 12 wherein said second shank is a second threaded bolt.

20. A method of using a retractable bracket device for attachment to an air deflector unit, the device for fitment onto a truck capable of pulling a trailer, the truck having a cab, a front bed wall, a first side bed wall, a second side bed wall and a flat bed flooring disposed between the front bed wall and the two side bed walls of the truck, said method comprising the steps of:
obtaining the device comprising:
a pedestal attachable to the truck, the pedestal including:
a first footer attachable to the first side bed wall of the truck;
a second footer attachable to the second side bed wall of the truck;
an arch attached to the first and second footers of the pedestal, the arch having a first post, a second post and a crossbar, the first post of the arch is attached to the first footer, the second post of the arch is attached to the second footer, the crossbar is attached to the first and second posts of the arch;
a first support gusset attached to the first footer and attached to the first post of the arch;
a second support gusset attached to the second footer and attached to the second post of the arch;
a first mounting flap attached to the first post of the arch, the first mounting flap having a first arcuately curved hook distal end defining a first crevice in the distal end of the first mounting flap; and
a second mounting flap attached to the second post of the arch, the second mounting flap having a second arcuately curved hook distal end defining a second crevice in the distal end of the second bracket;
a first hinge attached to the crossbar of the arch;
a second hinge attached to the crossbar of the arch;
an extender arm attached to the first and second hinges, whereby the extender arm is pivotally attached to the pedestal, the extender arm including:
a base member attached to the first and second hinges;
a first leg member attached to the base member, the first leg member having a first threaded shaft protruding outwardly from one side of the first leg member;
a second leg member attached to the base member, the second leg member having a second threaded shaft protruding outwardly from one side of the second leg member;
a first brace attached to the first leg member, the first brace having a first sleeve defining a first hole in the first brace; and
a second brace attached to the second leg member, the second brace having a second sleeve defining a second hole of the second brace,
wherein when the extender arm is pivoted towards the arch of the pedestal then the device is in a lower folded position, and
when the extender arm is pivoted away from the arch of the pedestal so that the respective first and second shafts of the first and second leg members of the extender arm are slidably inserted within the respective first and second crevices of the first and second mounting flaps then the device is in a straightened position;
a third hinge attached to the first leg member of the extender arm;
a fourth hinge attached to the second leg member of the extender arm;
a platform attached to the third and fourth hinges, whereby the platform is pivotally attached to the extender arm, the platform having a generally flat top and a bottom, the platform including:
a plurality of collars traversing through the top of the platform to the bottom of the platform, the plurality of collars defining a plurality of orifices in the platform, wherein the top of the platform and the plurality of orifices are for mounting onto the air deflector unit;
a first flange attached to the bottom of the platform, the first flange having a first interior annular wall defining a first aperture extending through the first flange; and
a second flange attached to the bottom of the platform, the second flange having a second interior annular wall defining a second aperture extending through the second flange,
wherein when the platform is pivoted towards the extender arm then the device is in an upper folded position, and
when the device is simultaneously in the lower folded position and in the upper folded position then the device is in the fully folded position;
a first threaded nut threadedly connectable to the first threaded shaft of the first leg member of the extender arm;
a second threaded nut threadedly connectable to the second threaded shaft of the second leg member of the extender arm,
wherein when the device is in the straightened position and when the respective first and second nuts are tightened over the respective first and second shafts then the device is in a lower locked position, and
when the platform is pivoted away from the extension arm so that the first and second braces of the extension arm contact the bottom of the platform then the device is in an semi-unfolded position;
a first shank insertable within the first aperture of the first flange of the platform, the first shank is also insertable within the first hole in the first brace; and
a second shank insertable within the second aperture of the first flange of the platform, the second shank is also insertable within the second hole of the second brace,
wherein when the device is the semi-unfolded position and when the respective first and second shanks are inserted within the respective first and second holes of the respective first and second braces and inserted through the respective first and
second apertures of the respective first and second flanges of the platform then the device is in an upper locked position, and
when the device is simultaneously in the lower locked position and is in the upper locked position then the device is in a fully extended position;
placing the device into the fully folded position;
attaching firmly the air deflector unit onto the top of the platform of the device;
adjoining the first footer of the pedestal of the device onto the first side bed wall of the truck;
affixing the second footer of the pedestal of the device onto the second side bed wall of the truck;
rotating pivotally the extender arm away from the arch of the pedestal so that the respective first and second shafts of the first and second leg members of the extender arm are slidably inserted within the respective first and second crevices of the first and second mounting flaps, whereby moving the device form the fully folded position to the straightened position;
tightening the respective first and second nuts onto the respective first and second shafts when the device is in the straightened position whereby moving the device from the straightened position to the lower locked position;
raising pivotally the platform away from the extension arm so that the first and second braces of the extension arm contact the bottom of the platform whereby moving the device from the lower locked position to the semi-unfolded position;
inserting the respective first and second shanks into the respective first and second holes of the respective first and second braces and through the respective first and second apertures of the respective first and second flanges of the platform, whereby moving the device from the semi-unfolded position to the fully extended position;
hooking up the trailer to the truck;
towing the trailer with the truck when the device is in the fully extended position and when the air deflector unit is attached to the device;
unhooking the trailer from the truck;
withdrawing the respective first and second shanks from the respective first and second holes of the respective first and second braces and from the respective first and second apertures of the respective first and second flanges of the platform, whereby moving the device from the fully extended position to the semi-unfolded position;
swinging pivotally the platform towards the extender arm, whereby moving the device form the semi-unfolded position to the upper folded position;
loosening the first and second nuts from the respective first and second shafts, whereby moving the device form the upper folded position to the straightened position; and
revolving pivotally the extender arm towards the arch of the pedestal, whereby moving the device from the straightened position to the fully folded position.
